(19) United States
(12) Patent Application Publication
(10) Pub. No.: US 2019/0110952 A1
(43) Pub. Date: Apr. 18, 2019

(54) TAMPER PROOF LOCKBOX FOR A MEDICINE CABINET

(71) Applicant: William Wallace, Erin Springs, OK (US)

(72) Inventor: William Wallace, Erin Springs, OK (US)

(21) Appl. No.: 16/153,937

(22) Filed: Oct. 8, 2018

Related U.S. Application Data
(60) Provisional application No. 62/572,739, filed on Oct. 16, 2017.

(51) Int. Cl. A61J 1/00; E05G 1/00; E05G 1/04

(52) U.S. Cl. CPC A61J 1/00; E05G 1/04; E05G 1/005

(57) ABSTRACT

A lockbox to store medication therein and to be secured within a medicine cabinet, the lockbox including a main body to fit into the medicine cabinet, a door disposed at a front portion of the main body, a plurality of anchor holes disposed within the main body to allow the main body to be secured to at least one wall or shelf within the medicine cabinet, and a lock to disposed at a top portion of the door to prevent the door from opening when the lock is locked.

### CROSS REFERENCE TO RELATED APPLICATIONS

This application claims the benefit of U.S. Provisional Patent Application No. 62/572,739, filed Oct. 16, 2017 and entitled “TAMPER PROOF LOCKBOX FOR A MEDICINE CABINET,” the entire disclosure of which is incorporated herein by reference.

### BACKGROUND

### 1. Field

The present general inventive concept relates generally to a medicine cabinet, and more specifically, to a medicine cabinet including a tamper-proof lockbox.

### 2. Description of the Related Art

Most bathrooms include conventional medicine cabinets, which allow people to store various items therein, including, but not limited to, medicine, toothbrushes, floss, razors, toothpaste, creams, perfumes, cotton balls, soap, shampoo, combs, brushes, makeup, nail polish, alcohol, hydrogen peroxide, baking soda, mouth wash, and manicure equipment.

However, various types of prescription medication on the market today, which may be found in a particular user's medicine cabinet, may be alternatively used in art abusive and dangerous manner. Although abusing prescription medicine is not recommended, sometimes children who do not know any better may choose to “experiment” with medication such as VICODIN, and OXYCONTIN, AND OXYCODONE.

As such, there is a need for a secure lockbox within a medicine cabinet that allows a user to secure potentially dangerous items thereinside, while not inhibiting access to non-dangerous items within the medicine cabinet, such as soap and toothbrushes.

### SUMMARY

The present general inventive concept provides a lockbox within a medicine cabinet, which secures potentially dangerous items thereinside while allowing a user to access non-dangerous items within the medicine cabinet.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a lockbox to store medication therein and to be secured within a medicine cabinet, the lockbox including a main body to fit into the medicine cabinet, a door disposed at a front portion of the main body, a plurality of anchor holes disposed within the main body to allow the main body to be secured to at least one wall or shelf within the medicine cabinet, and a lock to disposed at a top portion of the door to prevent the door from opening when the lock is locked.

The lock may be at least one of a key-lock, a pin-and-tumbler lock, a combination lock, an electronic keypad lock, a touchpad lock, a voice recognition lock, a retinal-scanning lock, a fingerprint lock, and a mobile device-connectable lock that may be opened and/or locked via communication with the mobile device via BLUETOOTH, near-field communication, WIFI, or RFID communication.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 is a diagram illustrating a lockbox disposed within a medicine cabinet, according to an exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

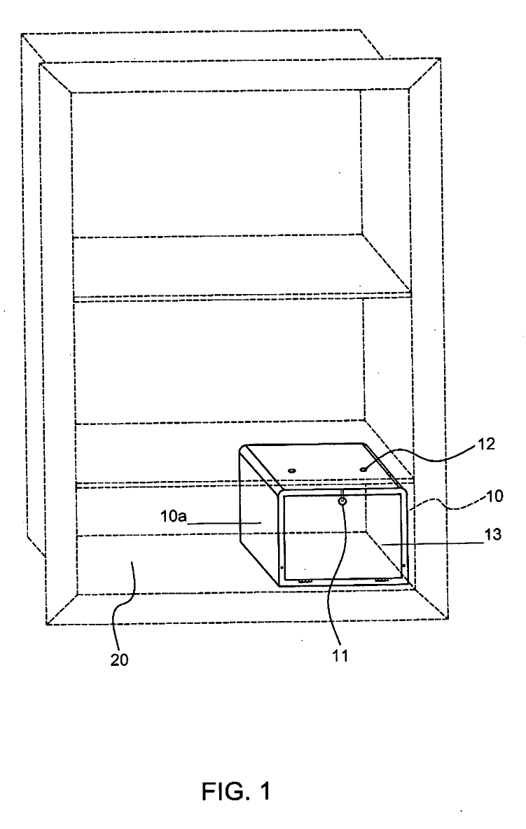

FIG. 1 is a diagram illustrating a lockbox 10 disposed within a medicine cabinet 20, according to an exemplary embodiment of the present general inventive concept.

Referring to FIG. 1, the medicine cabinet 20 may be any type of medicine cabinet, and may be made from any type of material, including, but not limited to, wood, plastic, metal, porcelain, etc.

The medicine cabinet 20 may be designed with a plurality of shelves to allow users to store various items within the medicine cabinet 20, including, but not limited to, items such as toothbrushes, floss, razors, toothpaste, creams, perfumes, cotton balls, soap, shampoo, combs, brushes, makeup, nail polish, alcohol, hydrogen peroxide, baking soda, mouth wash, and manicure equipment.

The medicine cabinet 20 may also securely store the lockbox 10 therein. The lockbox 10 may be stored at any location within the medicine cabinet 20. For ease of description, the lockbox 10 is illustrated in FIG. 1 as being stored in a bottom-right-hand-corner of the medicine cabinet 20.

Referring to FIG. 1, the lockbox 10 may include a main body 10a, a lock 11 and anchor holes 12.

The main body 10a may have a shape of a rectangular prism, and may be made of any material known to one of ordinary skill in the art, but preferably, of a material that is difficult to penetrate, such as metal.

The lock 11 may be any type of tamper-proof lock, including, but not limited to, a key-lock, a pin-and-tumbler lock, a combination lock, an electronic keypad lock, a touchpad lock, a voice recognition lock, a retinal-scanning lock, a fingerprint lock, and a mobile device-connectable lock that may be opened and/or locked via communication with the mobile device via BLUETOOTH, near-field communication, WIFI, or RFID communication, and any combination of locks described above.

The lock 11 may be child-proof, and may allow a door 13 disposed on a front portion of the main body 10a of the lockbox 10 to be unopenable when the lock 11 is locked. However, the door 13 may be opened when the lock 11 is unlocked.

A purpose of the lockbox 10 may be to allow a user to store prescription medication thereinside, such that the prescription medication is not accessible to users who are not authorized to open the lockbox 10. For example, if a child does not possess a key or a code to the lockbox 10, the child cannot open the lockbox 10 to gain access to the prescription medication thereinside. However, the child can still brush his/her teeth using the toothbrush and the toothpaste stored within the medicine cabinet 20.

The anchor holes 12 may be included to secure the lockbox 10 within the medicine cabinet 20. The anchor holes 12 may be formed to receive various types of screws, bolts, nails, or other securing devices to allow the lockbox 10 to be securely attached to a shelve within the medicine cabinet 20, for example. Although only two anchor holes 12 are illustrated in FIG. 1 at a top portion of the lockbox 10, any number of anchor holes 12 may be provided within the lockbox 10 in order to maximize securing of the lockbox 10 at least one shelf and/or wall disposed within the medicine cabinet 20. As such, the anchor holes 12, and the securing mechanisms used in conjunction with the anchor holes 12, prevent the lockbox 10 from being removable from the medicine cabinet 20.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A lockbox to store medication therein and to be secured within a medicine cabinet, the lockbox comprising:
a main body to fit into the medicine cabinet;
a door disposed at a front portion of the main body;
a plurality of anchor holes disposed within the main body to allow the main body to be secured to at least one wall or shelf within the medicine cabinet; and
a lock to disposed at a top portion of the door to prevent the door from opening when the lock is locked.

2. The lockbox of claim 1, wherein the lock is at least one of a key-lock, a pin-and-tumbler lock, a combination lock, an electronic keypad lock, a touchpad lock, a voice recognition lock, a retinal-scanning lock, a fingerprint lock, and a mobile device-connectable lock that may be opened and/or locked via communication with the mobile device via BLUETOOTH, near-field communication, WIFI, or RFID communication.
